(19) United States
(12) Patent Application Publication
(10) Pub. No.: US 2006/0204638 A1
(43) Pub. Date: Sep. 14, 2006

(54) Low-fat sweet potato chip processing method

(76) Inventors: Ho-Hsien Chen, Neipu (TW); Tzou-Chi Huang, Neipu (TW)

Correspondence Address: PRO-TECTOR INTERNATIONAL SERVICES, 20775 NORADA CT., SARATOGA, CA, 95070, US

(21) Appl. No.: 11/258,945

(22) Filed: Oct. 25, 2005

(30) Foreign Application Priority Data
Mar. 11, 2005 (TW) 94107412

(51) Int. Cl. A23L 1/216

(52) U.S. Cl. 426/637

(57) ABSTRACT

A method of processing low-fat sweet potatoes chips having the characteristics of porosity and crispness is disclosed to include the steps of (a) cutting sweet potatoes into sweet potatoes chips, (b) blanching the sweet potatoes chips with SAPP solution, (c) pre-drying the blanched sweet potatoes chips, (d) coating the pre-dried blanched sweet potatoes chips with a shortening oil, and (e) heating the sweet potatoes chips thus obtained with a superheated steam.

### BACKGROUND OF THE INVENTION

1. Field of the Invention

The present invention relates to food processing method and more particularly, to a low-fat sweet potato chip processing method for processing low-fat sweet potatoes chips by superheated steam under particularly controlled conditions.

2. Description of the Related Art

Sweet potato is one of the major roots crops grown in Taiwan. Sweet potato chip, a kind of processed products made of sweet potato, has a higher acceptability in the market. The major problem encountered during processing of sweet potato is the storage of the material. The foodstuff of sweet potato will change during storage, resulting in deterioration of quality and difficulty in quality control. Further, commercial frying sweet potatoes chips have oil content more than 39.2%. Frying sweet potatoes chips will produce the carcinogen of PAH (poly-cyclic aromatic hydrocarbon) that is very harmful to the health of the human body.

Sweden's National Food Administration made a study in 2002 that showed a high content of acrylamide in frying foods such as drying potatoes chips. Similar studies made in the USA, UK, Swiss, Norway, and etc. confirmed this report. WHO and UN Food and Agriculture Organization held an acrylamide food safety administration consultant meeting. The meeting confirmed the fact of the existence of acrylamide in frying foods, and the need of a further study on acrylamide and its effect to produce cancer. Local studies made by National Taiwan University and Fu-Jen Catholic University, Taiwan, under the support of Taiwan's Health Administration showed a similar result.

Further, steam is the most common material used in food industry. Proper utilization of its characteristic can save the energy and promote the processing efficiency. The reheating of saturated steam is called superheated steam, which shows better dry effect than hot air drying. Its advantages showed not only the quick drying rate but also the surface of the food with not to being harden. Besides, the products can have effects such as oxidation-reduction, sterilization and deodorization. Compared with other mediums, superheated steam is the safest material and an ideal medium of directly heating like saturated steam and boiled water do.

Further, studies showed that compared with foods made of hot air, foods made of superheated steam have a better outer looking and the characteristic of porosity. Because superheated steam contains no impurity and is much pure than hot air, superheated steam ensures a better quality to reheating of high water content food.

### SUMMARY OF THE INVENTION

The present invention has been accomplished under the circumstances in view. The invention uses native sweet potatoes (TW66) along with superheated steam as a medium to process the experiment. The results showed that optimal conditions by Grey-Taguchi method were thickness 0.2-0,3 cm, pre-drying time 4-8 mins, SAPP concentration 0.2-0.4%, blanching time within 3-5 mins, superheated steam 140° C.-145° C., heating time 9-12 mins, with shortening oil. The crude fat of sweet potatoes chips made of superheated steam is between 5.22%-7.52%, and is lower than the commercial frying sweet potatoes chips, therefore sweet potatoes chips made of superheated steam are more health to our health. Besides, the results of texture profile analysis and scanning electron microscopy showed that compared with commercial frying sweet potatoes chips, the ones made of superheated steam have characteristics of porosity and crispness.

### BRIEF DESCRIPTION OF THE DRAWINGS

FIG. 1 is a manufacturing flow chart of a low-fat potato chip processing method according to the present invention.

FIG. 2 is a parameter-level chart made according to the present invention.

FIG. 3 shows a L₁₈(2¹×3⁷) standard orthogonal array made according to the present invention.

FIG. 4 is a sensory evaluation chart made on different sweet potatoes chips according to the present invention.

FIG. 5 illustrates a quality characteristic S/N ratio of different sweet potatoes chips according to the present invention.

FIG. 6 is a quality characteristic data list according to the present invention.

FIG. 7 illustrates the order of sweet potatoes chips subject to ideal sequence and Grey Relation Grade.

FIG. 8 is a sweet potatoes chips Grey-Taguchi Response Table according to the present invention.

FIG. 9 is a sweet potatoes chips Grey-Taguchi Response Graph according to the present invention.

FIG. 10 is a sweet potatoes chip Grey-Taguchi ANOVA analysis table according to the present invention.

FIG. 11 illustrates the crude fat content of different groups of sweet potatoes chips.

FIG. 12A is a TPA weighted diagram of raw sweet potatoes chips by Grey Taguchi method.

FIG. 12B is a TPA weighted diagram of commercial frying sweet potatoes chips by Grey Taguchi method.

FIG. 12C is a TPA weighted diagram of optimal sweet potatoes chips by Grey Taguchi method.

FIG. 13 is a factorial ANOVA (Analysis of Variance), based on hardness, according to the present invention.

FIG. 14A is a 800× scanning electron microscopy diagram made on raw sweet potatoes chips.

FIG. 14B is a 800× scanning electron microscopy diagram made on commercial frying sweet potatoes chips.

FIG. 14C is a 800× scanning electron microscopy diagram made on optical sweet potatoes chips made of superheated steam according to the present invention.

FIG. 15A is a 60× scanning electron microscopy diagram made on commercial frying sweet potatoes chips.

FIG. 15B is a 60× scanning electron microscopy diagram made on optical sweet potatoes chips made of superheated steam according to the present invention.

### DETAILED DESCRIPTION OF THE PREFERRED EMBODIMENT

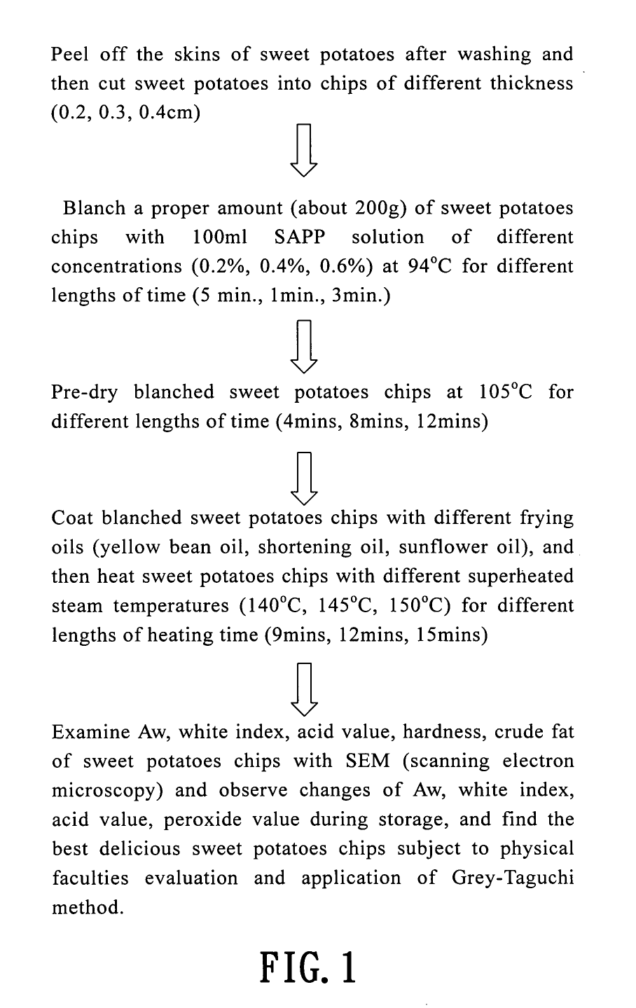

Referring to FIG. 1, the low-fat potato chip processing method is to peel off the skins of sweet potatoes after washing and then to cut sweet potatoes into chips, and then to blanch sweet potatoes chips with SAPP and to coat blanched sweet potatoes chips with shortening oil, and then to dry potatoes chips with superheated steam. Thereafter, examine Aw, white index, acid value, hardness, crude fat of sweet potatoes chips with SEM (scanning electron microscopy), and then observe changes of Aw, white index, acid value, peroxide value during storage so as to find best delicious sweet potatoes chips subject to physical faculties evaluation and application of Grey-Taguchi method.

Actual experimentation of the invention is outlined hereinafter:

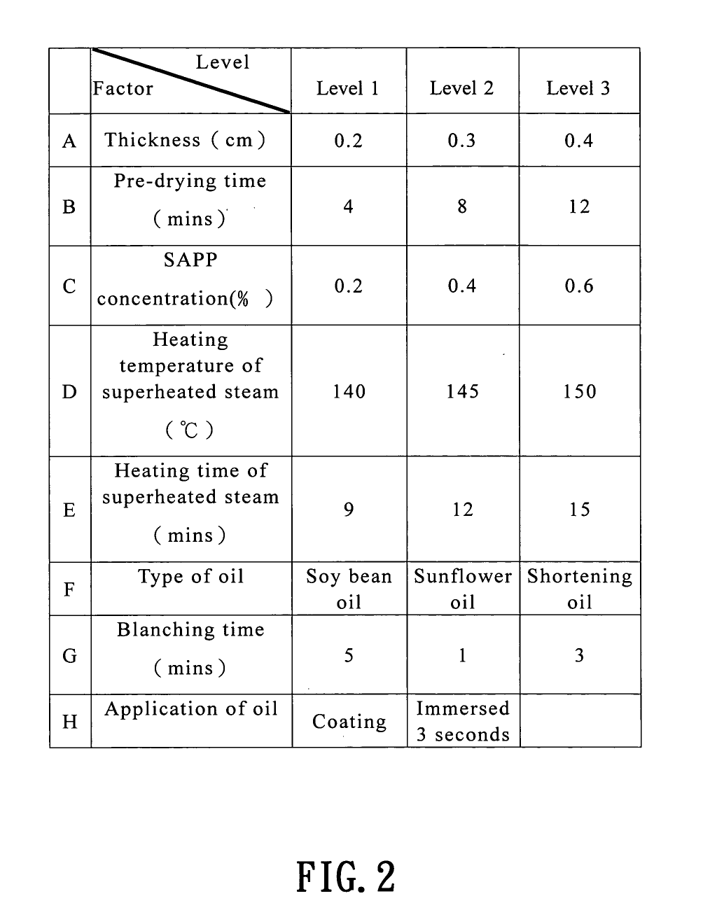

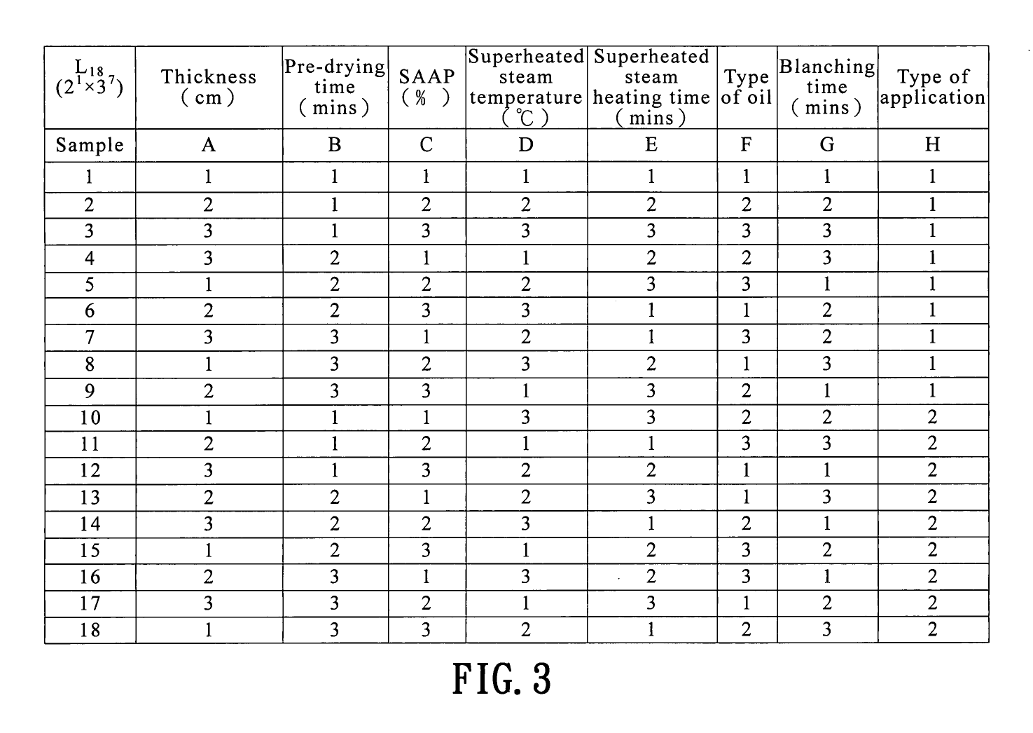

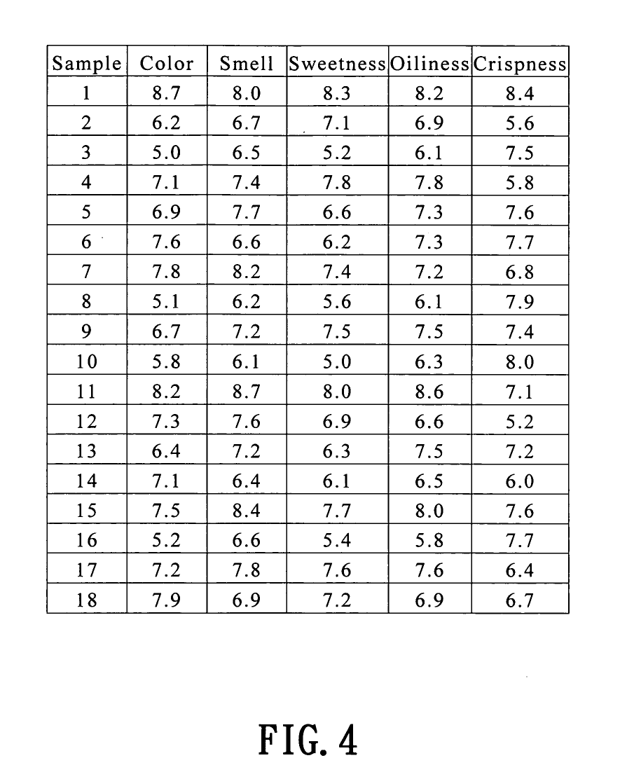

1. The invention preceded the experiment with different conditions as shown in FIG. 1, and analysis was made by using L₁₈(2¹×3⁷) standard orthogonal array subject to Taguchi method. There were total 8 control factors including 7 three-level factors and 1 two-level factor. Parameters and factions were arranged as shown in FIG. 2. Arrangement of the L₁₈(2¹×3⁷) standard orthogonal array was made as shown in FIG. 3. The sensory evaluation chart was made as shown in FIG. 4. The chart was obtained from 18 trials of sweet potatoes chips made subject to FIG. 3 and evaluated by 15 trained panelists. Factors to examine included appearance, smell, and taste. A nine-point evaluation system was used to evaluate the sweet potatoes chips on color, smell, sweetness, oiliness, and crispness. The nine-point evaluation system is to give 1˜9 points (9 points for red color, strong sweet smell, very sweet, not oily, very crisp; 1 point for brown color, weak sweet smell, not sweet, oily, not crisp). After evaluation on every item, the average value was obtained on each item. The higher the score is the greater the acceptability of consumers will be.

2. Quality characteristics were converted into S/N ratio subject to Taguchi method, and S/N ratio thus obtained was used to find the design of best quality and smallest variation. Calculation of S/N ratio was:

Larger-is-better characteristic

$$η = - 10 log ( \frac{1}{n} {\sum }_{i = 1}^{n} \frac{1}{{y}_{i}^{2}} ) db$$

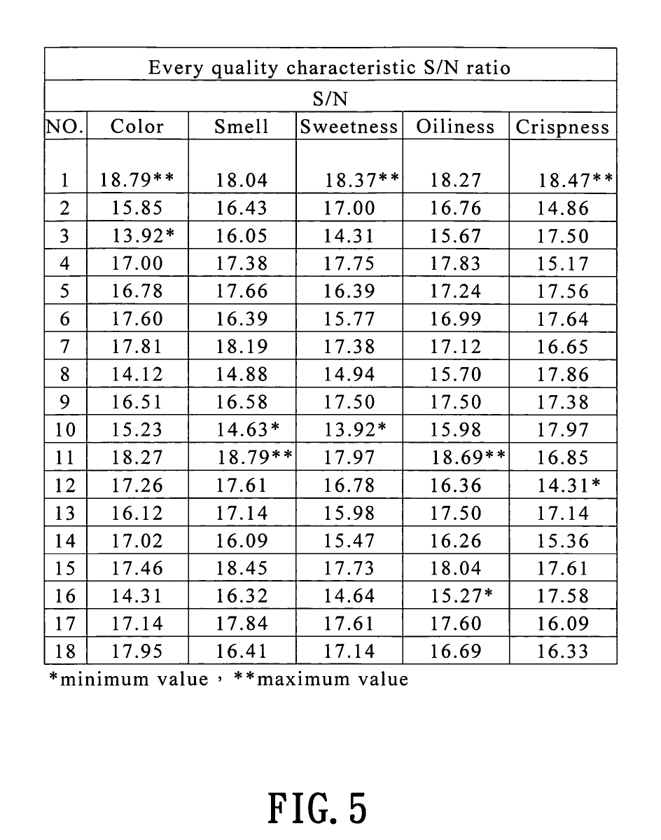

η is characteristic of S/N ratio; db is the decibel (dB) unit of S/N ratio. Either characteristic adopted, the greater η value (S/N ratio) showed the better processing characteristic. With respect to objective characteristic, color, smell, sweetness, oiliness and crispness had a larger-is-better characteristic. Examined data on L₁₈ orthogonal array was recorded and converted into S/N ratio subject to Taguchi larger-is-better characteristic, S/N ratio of sweet potatoes chips on every quality characteristic was obtained as shown in FIG. 5.

3. After every quality characteristic had been analyzed through S/N ratio characteristic analysis, all S/N ratio data were converted into a value between 0-1, For example, the result of the color on the first trial in FIG. 5 was as follows:

$${x}_{j}^{*} ( k ) = \frac{{x}_{j}^{( 0 )} ( k ) - min [ {x}_{j}^{( 0 )} ( k ) ]}{max [ {x}_{j}^{( 0 )} ( k ) ] - min [ {x}_{j}^{( 0 )} ( k ) ]} ⇒ {x}_{1}^{*} ( 1 ) = \frac{18.79 - 13.92}{18.79 - 13.92} = 1$$

wherein max[x₁⁽⁰⁾(k)]=18.79; and min[x₁⁽⁰⁾(k)]=13.92;

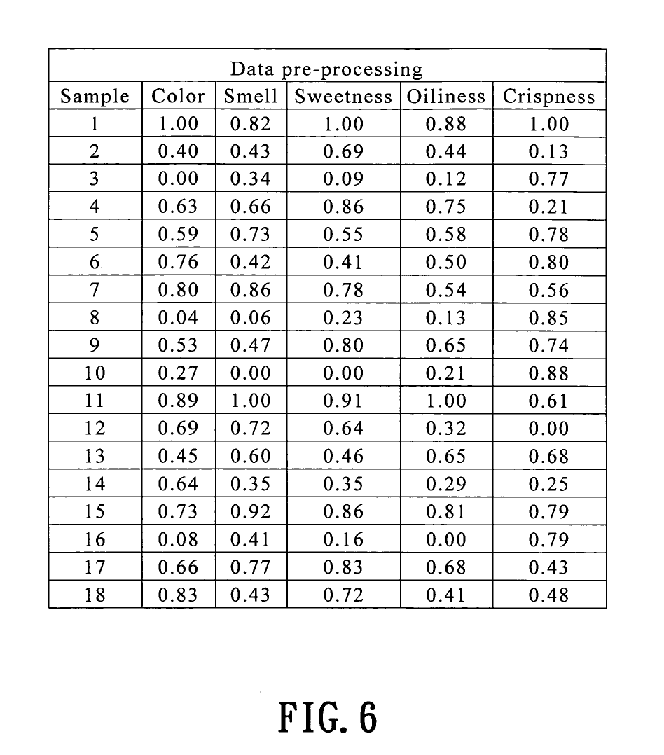

Thus, the first trial was calculated to be color: 1.00; Smell 0.82; Sweetness: 1.00; Oiliness: 0.88; crisp: 1.00. Other experimentation groups were examined in the same manner, and the chart shown in FIG. 6 was thus obtained.

4. Calculated coefficient of Grey Relation subject to FIG. 6 as follows: ( Followed the method revealed in “Ho-Hsien Chen, Pi-Jen Tsai, Shyn-Huang Chen, Yu-Ming Su, Chao-Chin Chung, Tzou-Chi Huang, 2005, Grey relational analysis of dried roselle (Hibiscus sabdariffa L.). Journal of Food Processing and Preservation 29: 228-245.)

$$γ ( {x}_{0} ( k ) , {x}_{j} ( k ) ) = \frac{{Δ}_{min} + {ζΔ}_{max}}{{Δ}_{0 j} ( k ) + {ζΔ}_{max}}$$

$$j = 1 , … , m , k = 1 , … n$$

wherein x₀(k) was the ideal sequence (1.00, 1.00, 1.00, 1.00, 1.00), x₁(k) was the first trial sequence (1.00, 0.73, 1.00, 0.80, 1.00)

$$γ ( {x}_{0} ( 1 ) , {x}_{1} ( 1 ) ) = \frac{0 + .0 .5 * 1}{0 + 0.5 * 1} = 1$$

wherein Δmin=0, Δmax=1, ζ=0.5, Δ₀₁(1)=1−1=0

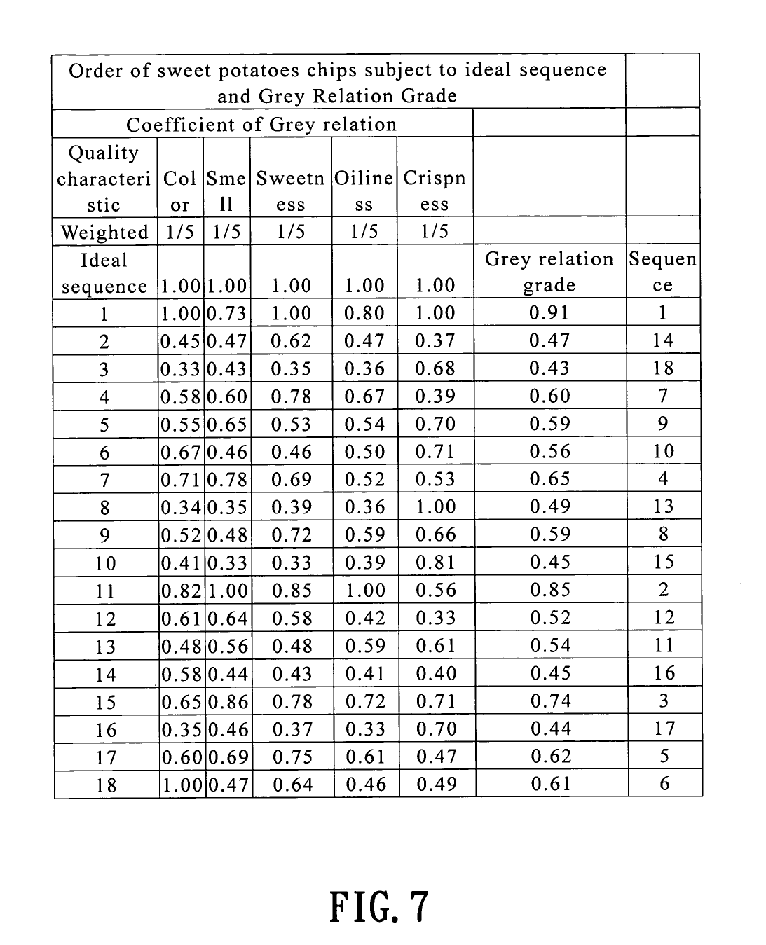

Thus, the coefficient of Grey Relation was calculated to be 1.00 for the color of the first trial, 0.45 for the color of the second trial, and so on, as shown in FIG. 7.

5. Grey Relation Grade was Calculated as Follows:

Subject to the aforesaid method, the coefficient of Grey Relation of the first group on color, smell, sweetness, oiliness and crispness are to be 1.00, 0.73, 1.00, 0.80 and 1.00. By means of coefficient of Grey Relation of quality characteristic, Grey Relation Grade of the first group was calculated to be:

$$Γ ( {x}_{0} , {x}_{j} ) = {\sum }_{k = 1}^{n} {β}_{K} γ ( {x}_{0} ( k ) , {x}_{j} ( k ) ) ⇒ Γ ( {x}_{0} , {x}_{1} ) = \frac{1}{5} ( 1.00 + 0.73 + 1.00 + 0.80 + 1.00 ) = 0.91$$

wherein βₖ was ⅕, thus Grey Relation Grade was calculated to be 0.91 for the first trial and 0.47 for the second trial, and other trials were calculated in the same manner. The greater the Grey Relation Grade is the better the product quality characteristic and the closer the product quality to the ideal value will be. From the table shown in FIG. 7, it is understood that the Grey Relation Grade of the first group is 0.91, which is the one closest to the ideal sequence. The order of the other trials arranged subject to their closeness to the ideal sequence is the 11^{th} trial>15^{th} trial>7^{th} trial>17^{th} trial>18^{th} trial >4^{th} trial>9^{th} trial>5^{th} trial>6^{th} trial>13^{th} trial>12^{th} trial>8^{th} trial>2^{nd} trial>10^{th} trial>14^{th} trial>16^{th} trial>3^{rd}.

6. Prepared Sweet Potatoes Chip Grey Taguchi Response Table and Graph, and Made the Related Analysis:

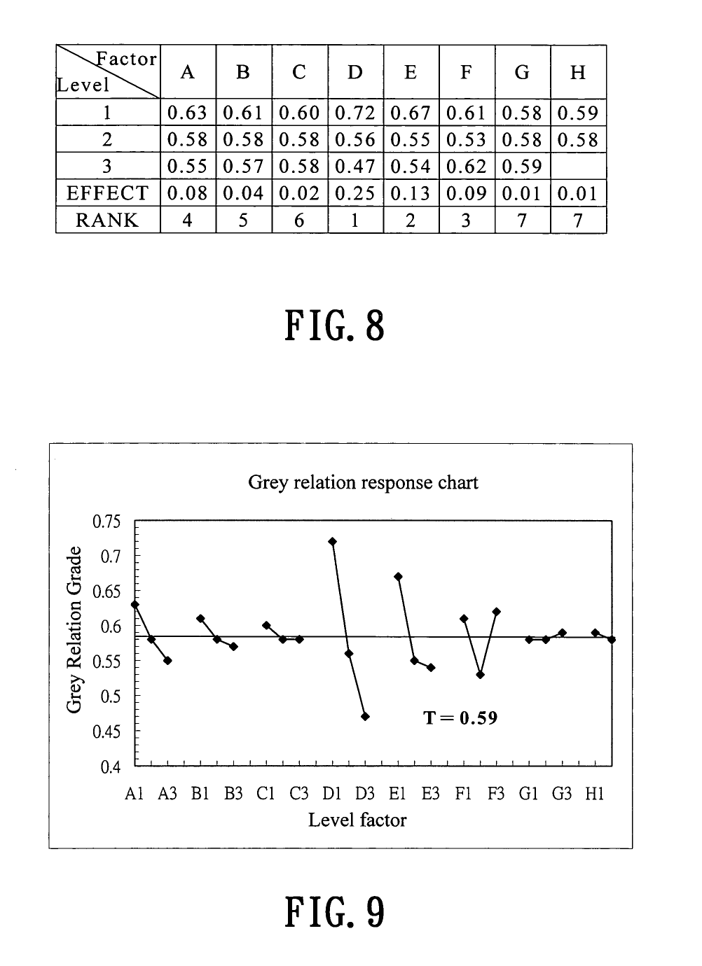

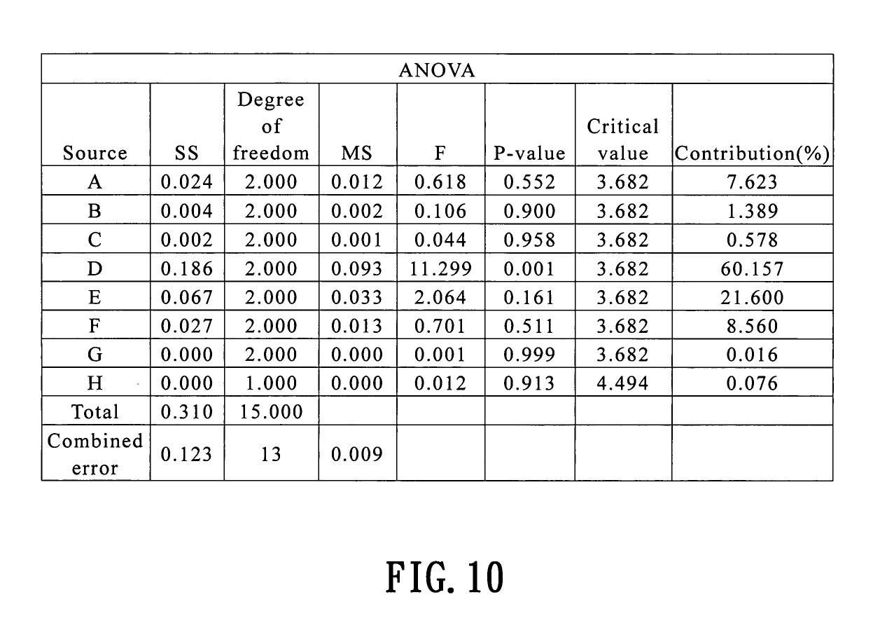

On the example of the value 0.63 for level-i on A factor (thickness of sweet potatoes chips), as shown in the orthogonal array in FIG. 3, Level-1 of A factor to be at the 1^{st}, 5^{th}, 8^{th}, 10^{th}, 15^{th} and 18^{th} trials, respectively. The Grey Relation Grade values of these 6 trials were summed up to obtain the mean value. This mean value was the value of Level-1 for A factor, i.e., (0.91+0.59+0.49+0.45+0.74+0.61)/6=0.63. The values for other factors were calculated in the same way. Effects of Grey-Taguchi Response Table in FIG. 8 were obtained subject to the calculation of deducting the smallest value of every level from the greatest value of the respective level. The response Graph in FIG. 9 was obtained subject to the response table in FIG. 8. From the Response Table and Response Graph shown in FIGS. 8 and 9, it showed the optimal factor range to be thickness of potatoes chips within 0.2 cm-0.3 cm; SAPP concentration within 0.2-0.4%, blanching time within 3-5 mins, pre-drying time within 4-8 mins, superheated steam heating temperature within 140° C.-145° C., and heating time within 9-12 mins. The results showed that optimal conditions were A1 (thickness: 0.2cm), B1 (drying time: 4 mins), C1 (SAPP concentration: 0.2%), D1 (superheated stem 140° C.), E1 (heating time: 9 mins), F3 (shortening oil), G1 (blanching: 3 mins), H1 (oil coating). FIG. 10 is a sweet potatoes chips Grey-Taguchi ANOVA analysis table according to the present invention. As shown in FIG. 10, the most significant factor is factor D: heating temperature of superheated steam, its F value 11.299>critical value 3.682, its P value<0.05, and its contribution % is 60.16%; the second significant factor is factor E: heating time of superheated steam, its contribution % is 21.66%. In the whole multi-item quality experimentation, well control of these two factors (heating temperature of superheated steam and heating time of superheated steam) achieves fabrication of ideal quality products. Further, pre-drying temperature is preferably controlled at 105° C. (see FIG. 1).

From the aforesaid experimentation and analysis, it is apparent that the optimal factor range is: thickness of potatoes chips within 0.2 cm-0.3 cm; SAPP concentration within 0.2-0.4%, blanching time within 3-5 mins, pre-drying time within 4-8 mins, superheated steam heating temperature within 140° C.-145° C., and heating time within 9-12 mins; the most optimal factor combination is: A1 (thickness: 0.2cm), B1 (drying time: 4 mins), C1 (SAPP concentration: 0.2%), D1 (superheated stem 140° C.), E1 (heating time: 9 mins), F3 (shortening oil), G1 (blanching: 3 mins), H1 (oil coating). The crude fat of sweet potatoes chips made of superheated steam is between 5.22%-7.52%. Crude fat was tested by: drying the receiver to a constant weight with 105° C. and measured the weight to be X1, and then ground the sample and measured the weight of the sample to be X2, and then extracted fat from sample with ethyl ether for 8-16 hours and then measured the weight of the receiver with the fat in the receiver to be X3. Crude fat was calculated as follow:

$$Crude fat \% = \frac{X 3 - X 1}{X 2} \times 100 \%$$

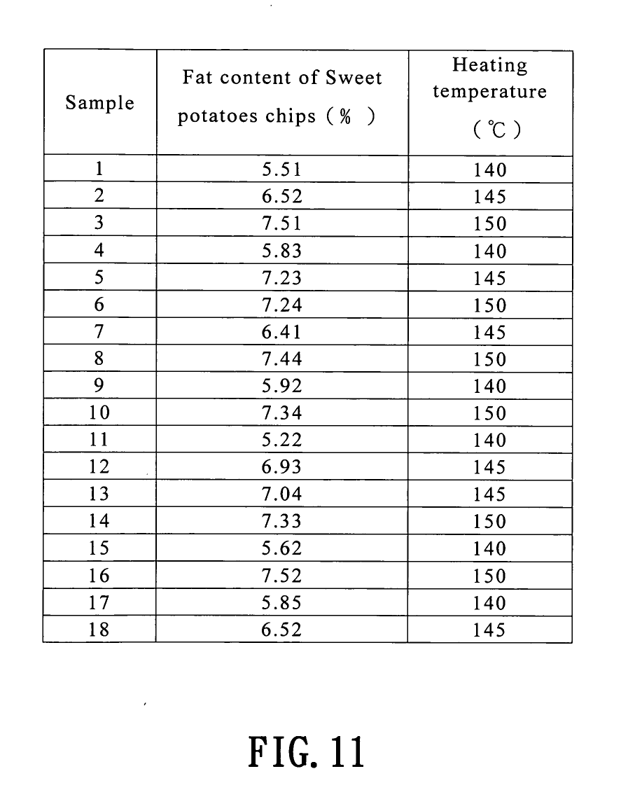

Crude fat of sweet potatoes chips made of superheated steam, as shown in FIG. 11, is lower than the commercial frying sweet potatoes chips, which have about 39.2%.

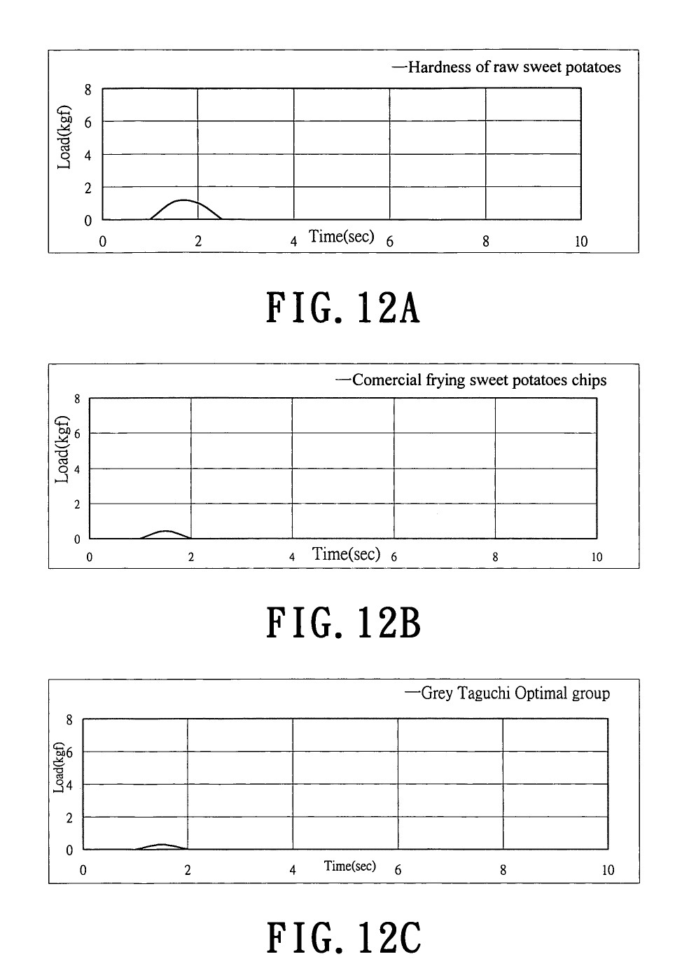

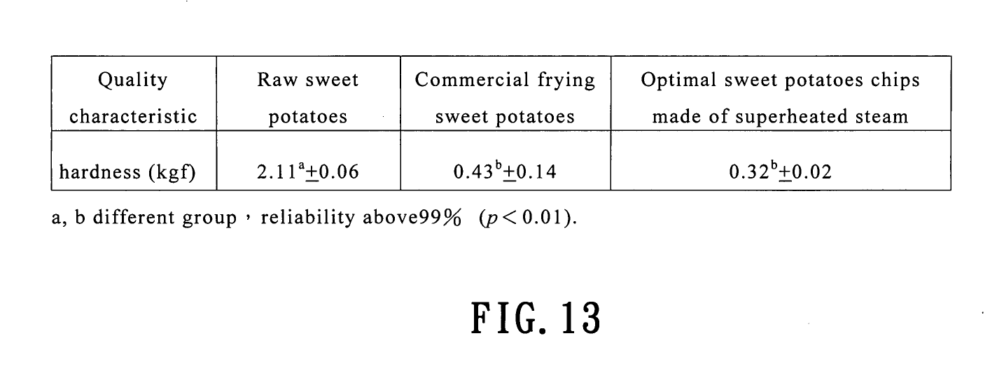

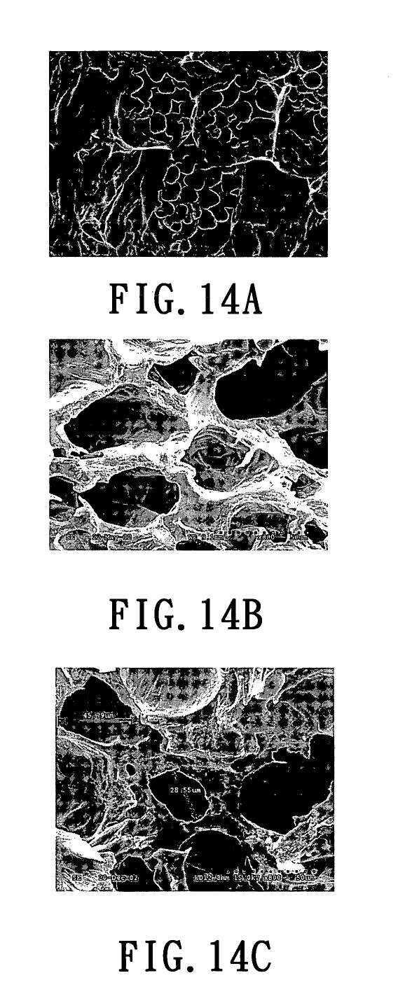

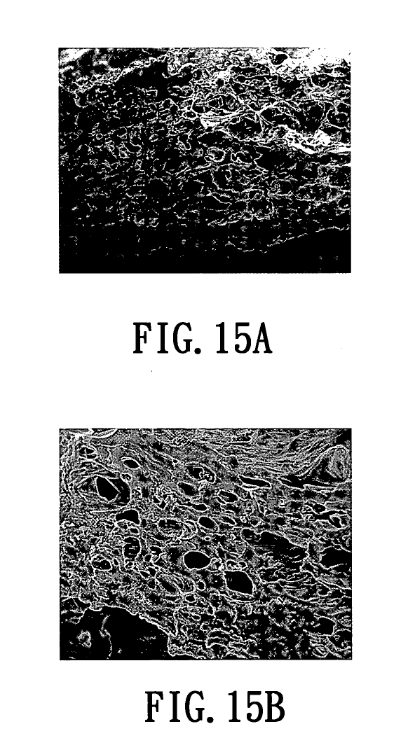

Further, with respect to crispness, please refer to TPA weighted diagram of raw sweet potatoes, commercial frying sweet potatoes chips, and optimal sweet potatoes chips by Grey-Taguchi method(see FIGS. 12A-12B-12C), average hardness is 1.21 kgf for raw sweet potatoes, 0.428 kgf for commercial frying potatoes chips, and 0.297 kgf for optimal sweet potatoes chips by Grey-Taguchi method. The results showed that raw sweet potatoes had a high water content and soft texture profile. The result of texture profile analysis showed a high hardness value. Actually, it was the indication of toughness. Because of high water content and soft texture profile, the chips are not easy to break. As shown in the diagram, the results of texture profile analysis showed that compared with commercial frying sweet potatoes chips and raw potatoes chips, the ones made of superheated steam have characteristics of porosity and crispness. FIG. 13 is a factorial ANOVA (Analysis of Variance). The results showed that compared with commercial frying sweet potatoes chips and raw potatoes chips, the ones made of superheated steam have characteristics of crispness. FIGS. 14A-14B-14C are 800× scanning electron microscopy diagrams made on raw sweet potatoes chips (see FIG. 14A),commercial frying sweet potatoes chips (see FIG. 14B), and optical sweet potatoes chips made of superheated steam (see FIG. 14C). The main ingredient of sweet potatoes is starch, which exists in potatoes' cambium and well protected by cell walls. As shown in the diagram, starch grains tightly arranged together within the cell walls in raw potatoes, and the cell is maintained intact in a spherical shape. FIGS. 15A-15B are 60× scanning electron microscopy diagrams made on commercial frying sweet potatoes chips (see FIG. 15A) and optical sweet potatoes chips made of superheated steam (see FIG. 15B). The diagram showed the differences before and after heating. The shape of the cell wall of the sweet potatoes chips changed after heating. Starch grains were decomposed and gelatinized, forming many starch gels, and many beehive-like holes were seen. Compared with commercial frying sweet potatoes chips, the ones made of superheated steam have a greater number of pores. Further, the pores of sweet potatoes chips made of superheated steam have a relatively greater diameter than commercial frying sweet potatoes chips. Texture profile analysis showed the hardness value of sweet potatoes chips made of superheated steam was lower than commercial frying sweet potatoes chips. This result is in conformity with the scanning electron microscopy analysis. Therefore, all the results showed that that compared with commercial frying sweet potatoes chips, the ones made of superheated steam have characteristics of porosity and crispness.

The invention further analyzed acid value and peroxide value of all sweet potatoes chips. The results showed that shortening oil is the best, soy bean oil is the second best. Shortening oil has high saturation and low oxidation reaction speed. Therefore, the use of shortening oil provides a high stability in fat and the quality does not change easily at high temperature.

As indicated above, the invention used sweet potatoes along with superheated steam as a medium to proceed the experiment. The results showed that optimal conditions by Grey-Taguchi method were A1 (thickness: 0.2 cm), B1 (drying time: 4 mins), C1 (SAPP concentration: 0.2%), D1 (superheated stem 140° C.), E1 (heating time: 9 mins), F3 (shortening oil), G1 (blanching: 3 mins), H1 (oil coating). The most significant factors are the heating temperature and heating time of the superheated steam. The optimal products can be made when these two control factors are controlled.

Further, the crude fat of sweet potatoes chips made of superheated stem is much lower than commercial frying sweet potatoes chips, therefore sweet potatoes chips made of superheated steam are safer to our health. Because of the characteristic of porosity, sweet potatoes chips made of superheated steam are crisp. Under the optical conditions of controlled factors, sweet potatoes chips made of superheated steam have a low fat, a good taste and color, and a pleasant smell.

Although particular embodiments of the invention have been described in detail for purposes of illustration, various modifications and enhancements may be made without departing from the spirit and scope of the invention.

What the invention claimed is:

1. A low-fat sweet potato chip processing method comprising the steps of (a) cutting sweet potatoes into sweet potatoes chips, (b) blanching the sweet potatoes chips with SAPP solution, (c) pre-drying the blanched sweet potatoes chips, (d) coating the pre-dried blanched sweet potatoes chips with a shortening oil, and (e) heating the sweet potatoes chips thus obtained with a superheated steam.

2. The low-fat sweet potato chip processing method as claimed in claim 1, wherein the optimal processing conditions of the method are: the thickness of the sweet potatoes chips within 0.2 cm-0.3 cm; the concentration of SAPP solution within 0.2-0.4%, the blanching time within 3-5 mins, the pre-drying time within 4-8 mins, the superheated steam heating temperature within 140° C.-145° C., and the heating time within 9-12 mins.

3. The low-fat sweet potato chip processing method as claimed in claim 2, wherein the most preferable processing conditions of the method are: the thickness of the sweet potatoes chips at 0.2 cm; the concentration of SAPP solution at 0.2%, the blanching time at 3 mins, the pre-drying time at 4 mins, the superheated steam heating temperature at 140° C., and the heating time at 9 mins.

4. The low-fat sweet potato chip processing method as claimed in claim 3, wherein the pre-drying temperature is preferably at 105° C.
